(19) United States
(12) Patent Application Publication
(10) Pub. No.: US 2009/0313032 A1
(43) Pub. Date: Dec. 17, 2009

(54) Maintaining Energy Principal Preferences for a Vehicle by a Remote Preferences Service

(75) Inventors: James Lee Hafner, San Jose, CA (US); Melissa Wiltsey O'Mara, Tully, NY (US); Paul Stuart Williamson, Round Rock, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 12/139,562

(22) Filed: Jun. 16, 2008

(51) Int. Cl. G06Q 10/00

(52) U.S. Cl. 705/1

(57) ABSTRACT

A computer implemented method, apparatus, and computer usable program product for managing user preferences on remote computing device for utilization in electric vehicle charging transactions is provided. In one embodiment, in response to a determination that a set of preferences for an identified principal are available on a removable data storage device, a first preference service retrieves the set of preferences from the removable data storage device. In response to a determination that the set of preferences are stored on a second computing device associated with a second preference service, the first preference service sends a request for the set of preferences to the second preference service. The first preference service receives the set of preferences from the second preference service and sends the set of preferences to the energy transaction planner. The first preference service is a proxy for the energy transaction planner and the second preference service.

### BACKGROUND OF THE INVENTION

1. Field of the Invention

The present invention is related generally to an improved data processing system, and in particular, to a method and apparatus for managing electric vehicle charging transactions. More particularly, the present invention is directed to a computer implemented method, apparatus, and computer usable program code for a primary preference service located on a computing device that is remote to the electric vehicle for utilization in managing the electric vehicle charging transactions.

2. Description of the Related Art

Electric vehicles (EV) can be divided into two categories: totally electric vehicles (TEV) and plug-in hybrid electric vehicles (PHEV). Plug-in hybrid vehicles utilize two or more power sources to drive the vehicle. With the increasing costs of fossil fuels and concern over reliance on non-renewable resources, electric vehicles are poised to become a critical component of transportation systems throughout the world. Gasoline powered vehicles utilize the explosive power of a mixture of gasoline and air to propel the vehicle. In contrast, electric vehicles rely in whole or in part on electric power to drive the vehicle.

Electric vehicles contain electric storage mechanisms, such as batteries, to store electricity until it is needed to power the electric vehicle. The electric storage mechanisms require periodic charging to replenish the electric charge for continued operation. The electricity used to charge the electric storage mechanisms may be provided by any type of on-vehicle power generation and charging mechanism. The on-vehicle power generation and charging mechanisms may include consumptive power generation systems and/or non-consumptive power generation systems, such as, without limitation, fuel cells, gasoline powered combustion engines, bio-diesel powered engines, solar powered generators and regenerative braking systems.

In totally electric vehicles and plug-in hybrid electric vehicles, charging of the electric vehicles can also be accomplished by plugging the electric vehicle into an off-vehicle charging station. The off-vehicle charging station provides an external source of electricity, such as, an electric power grid. Totally electric vehicles require this type of off-vehicle charging in all cases. Off-vehicle charging is also likely to be significantly less expensive for plug-in hybrid electric vehicles than on-vehicle charging given currently available technology. Consequently off-vehicle charging may be the preferred charging mode for electric vehicle owners.

The power stored in the electric storage mechanisms on the electric vehicles and on-vehicle power generation mechanisms may be used to provide electricity back to the electricity grid. For electric vehicles to be used as suppliers of electric power to an electric power grid, electric vehicles are connected to an off-vehicle infrastructure which can efficiently consume the electricity generated or stored by the electric vehicle. To date, electric vehicle manufacturers and electric utility companies have only planned and provided infrastructure and methods for the most rudimentary charging scenario in which the electric vehicle is plugged into a common electric outlet.

### BRIEF SUMMARY OF THE INVENTION

According to one embodiment of the present invention, a computer implemented method, apparatus, and computer usable program product for managing user preferences on remote computing devices for utilization in electric vehicle charging transactions is provided. A first preference service on a first computing device receives a request for a set of preferences for an identified principal from an energy transaction planner. The first preference service makes a determination as to whether the set of preferences are available on a removable data storage device that is plugged into a port associated with the first computing device and accessible by the first preference service or whether the set of preferences are available on a second data storage device associated with a second preference service on a second computing device. A preference in the set of preferences specifies a parameter of an electric vehicle charging transaction that is to be minimized, maximized, or optimized.

In response to a determination that the set of preferences for the identified principal are available on the removable data storage device, the first preference service retrieves the set of preferences from the removable data storage device. In response to a determination that the set of preferences for the identified principal are stored on the second computing device associated with the second preference service, the first preference service sends a request for the set of preferences to the second preference service. The first preference service receives the set of preferences from the second preference service. The first preference service sends the set of preferences to the energy transaction planner. The first preference service is as a proxy for the energy transaction planner and the second preference service.

In another embodiment, a computer implemented method is provided for managing preferences for managing charging transactions for electric vehicles by a primary preference service. The primary preference service receives an identification of a principal associated with a client computing device using a user interface at the first computing device. The principal is an entity having an interest in an electric vehicle charging transaction. The charging transaction is a transaction associated with at least one of charging an electric vehicle, storing electric power in an electric storage mechanism associated with the electric vehicle, and de-charging the electric vehicle. The primary preference service receives a selection of preferences from the principal to form a set of preferences for the principal. The primary preference service stores the set of preferences on the removable data storage device in response to receiving a selection to store the set of preferences on a removable data storage device and determining that the removable data storage device is plugged into a port associated with the first computing device. When the principal unplugs the removable data storage device having the set of preferences stored thereon from the port on the first computing device and plugs the removable data storage device into a port associated with the second data storage device associated with a vehicle preference service, the vehicle preference service is able to copy the set of preferences from the removable data storage device onto a local data storage device associated with the second computing device.

In another embodiment, in response to receiving a selection to transmit the set of preferences to the vehicle preference service over a network interface, the primary preference service identifies a location of the vehicle preference service and sends the set of preferences to the vehicle preference service. The vehicle preference service saves the set of preferences for the principal onto the local data storage device associated with the second computing device for utilization in managing electric vehicle charging transactions associated with the principal.

### BRIEF DESCRIPTION OF THE SEVERAL VIEWS OF THE DRAWINGS

FIG. 1 is a block diagram of a network of data processing systems in which illustrative embodiments may be implemented;

FIG. 2 is a block diagram of a data processing system in which illustrative embodiments may be implemented;

FIG. 3 is a block diagram of an energy transaction infrastructure in accordance with an illustrative embodiment;

FIG. 4 is a block diagram of a vehicle preference managing system associated with an electric vehicle in accordance with an illustrative embodiment;

FIG. 5 is a block diagram of a proxy preference service and a primary preference service in accordance with an illustrative embodiment;

FIG. 6 is a block diagram of preference settings in accordance with an illustrative embodiment;

FIG. 7 is a block diagram of electric vehicle charging preferences in accordance with an illustrative embodiment;

FIG. 8 is a block diagram of principals in an electric vehicle charging transaction is depicted in accordance with an illustrative embodiment;

FIG. 9 is a flowchart illustrating a process for creating and storing preferences by a vehicle preference service in accordance with an illustrative embodiment;

FIG. 10 is a flowchart illustrating a process for retrieving preferences for a principal from a removable data storage device in accordance with an illustrative embodiment;

FIG. 11 is a flowchart illustrating a process for accessing preferences for a principal by a proxy preference service in accordance with an illustrative embodiment;

FIG. 12 is a flowchart illustrating a process for retrieving a set of preferences by a primary preference service in response to a request by a proxy preference service in accordance with an illustrative embodiment; and

FIG. 13 is a flowchart illustrating a process for identifying a set of preferences for an identified principal by a preference service in accordance with an illustrative embodiment.

### DETAILED DESCRIPTION OF THE INVENTION

As will be appreciated by one skilled in the art, the present invention may be embodied as a system, method, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer-usable or computer-readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer-usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

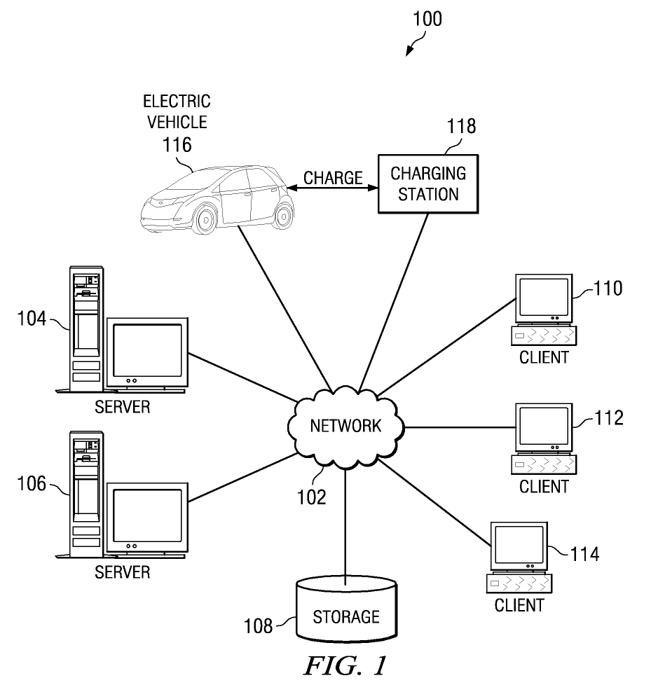

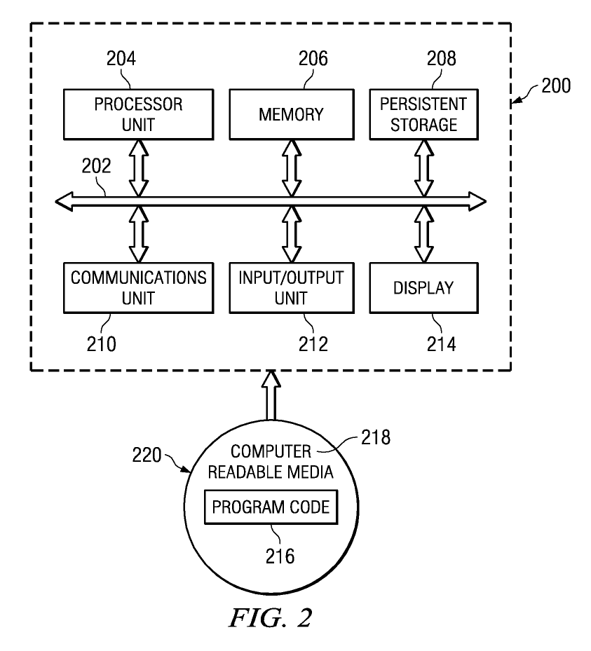

With reference now to the figures, and in particular, with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing system in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

Electric vehicle 116 is any vehicle that utilizes electric power in whole or in part to drive the vehicle that is capable of being plugged into charging station 118. Electric vehicle 116 may be a totally electric vehicle or a plug-in hybrid electric vehicle. The plug-in electric hybrid vehicle may be a gasoline/electric hybrid, a natural gas/electric hybrid, a diesel/electric hybrid, a bio-diesel/electric hybrid, or any other type of plug-in electric hybrid. Electric vehicle 116 may optionally include an on-vehicle power generation mechanism such as, but without limitation, solar power electric generators, gasoline powered electric generators, bio-diesel powered electric generators, regenerative breaking systems, or any other type of on-vehicle electric power generation mechanism.

Charging station 118 is any station, kiosk, garage, power outlet, or other facility for providing electricity to electric vehicle 116. Electric vehicle 116 receives electricity from, or provides electricity to, an electric grid at charging station 118. In other words, electric charge may flow from an electric grid through charging station 118 to electric vehicle 116 or the electric charge may flow from electric vehicle 116 back into the electric grid through charging station 118. Charging station 118 is a selected charge/discharge site, such as an outlet or kiosk, for providing electric vehicle 116 with access to the electric grid. For example, and without limitation, charging station 118 may be a power outlet in a privately owned garage, an electric outlet in a docking station in a commercially owned electric vehicle charging kiosk, or a power outlet in a commercially owned garage.

Electric vehicle 116 connects to charging station 118 via an electrical outlet or other electricity transfer mechanism. The electricity may also be optionally transferred via wireless energy transfer, also referred to as wireless power transfer, in which electrical energy is transferred to a load, such as electric vehicle 116, without interconnecting wires. The electricity may flow from charging station 118 into electric vehicle to charge electric vehicle 116. The electricity may also flow from electric vehicle 116 into charging station 118 to sell electricity back to the power grid.

Electric vehicle 116 and charging station 118 are optionally connected to network 102. Electric vehicle 116 and charging station 118 send and receive data associated with the charging of electric vehicle, the capabilities of electric vehicle, the capabilities of charging station 118, the current charge stored in electric vehicle, the rate of charging electric vehicle, the price of electricity received from a power grid, identity of the owner and/or operator of electric vehicle 116 and/or any other data relevant to charging or de-charging electric vehicle 116 over network 102.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer-usable program code or instructions implementing the processes may be located for the illustrative embodiments. Data processing system 200 may also be implemented as a computing device on-board an electric vehicle, such as electric vehicle 116 in FIG. 1.

In this illustrative example, data processing system 200 includes communications fabric 202, which provides communications between processor unit 204, memory 206, persistent storage 208, communications unit 210, input/output (I/O) unit 212, and display 214. Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206, in these examples, may be, for example, a random access memory or any other suitable volatile or non-volatile storage device. Persistent storage 208 may take various forms depending on the particular implementation. For example, persistent storage 208 may contain one or more components or devices. In another example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer-usable program code, or computer-readable program code that may be read and executed by a processor in processor unit 204. The program code in the different embodiments may be embodied on different physical or tangible computer-readable media, such as memory 206 or persistent storage 208.

Program code 216 is located in a functional form on computer-readable media 218 that is selectively removable and may be loaded onto or transferred to data processing system 200 for execution by processor unit 204. Program code 216 and computer-readable media 218 form computer program product 220 in these examples. In one example, computer-readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer-readable media 218 also may take the form of a persistent storage, such as a hard drive, a thumb drive, or a flash memory that is connected to data processing system 200. The tangible form of computer-readable media 218 is also referred to as computer-recordable storage media. In some instances, computer-recordable media 218 may not be removable.

Alternatively, program code 216 may be transferred to data processing system 200 from computer-readable media 218 through a communications link to communications unit 210 and/or through a connection to input/output unit 212. The communications link and/or the connection may be physical or wireless in the illustrative examples. The computer-readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

As one example, a storage device in data processing system 200 is any hardware apparatus that may store data. Memory 206, persistent storage 208, and computer-readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

Currently, electric vehicle manufacturers and electric utility companies have only planned and provided infrastructure for the most rudimentary charging scenarios, such as, merely plugging the electric vehicle into a common electric outlet that is owned by the owner and operator of the electric vehicle. The illustrative embodiments recognize that charging electric vehicles will frequently be conducted under much broader and more complex sets of circumstances than this simple scenario and infrastructure is needed to accommodate these complex transactions. For example, owners and operators of electric vehicles will frequently be required to charge their electric vehicle at a charging station that is remote from the home of the electric vehicle owner. In most circumstances, it is unlikely that the electric vehicle owner will own the off-vehicle charging stations from which the owner obtains electricity to recharge the electric vehicle. In such a situation, the owner or operator of the electric vehicle will likely be required to pay for the charge obtained from the off-vehicle charging station.

The illustrative embodiments recognize that the charging transactions by which electric vehicles obtain electricity from an off-vehicle charging station to charge the electric vehicle requires a much more complete, flexible, and interoperable system governing all aspects of the charging transaction. Electric vehicle charging transactions can be divided into the pre-charge phase, the charge phase, and the post-charge phase.

During the pre-charge phase of decision enablement, a charging plan is generated and all parties are presented with the conditions governing the charging transaction. During the charging phase, electricity flows to, from, or is stored in the electric vehicle. Finally, during the post-charge phase of the transaction, payment is made and an analysis is performed to provide incentives and induce specific behaviors on the part of one or more principals involved in the transaction. Additional charging infrastructure may also be provided to meter electricity at the point of charge, identify the various parties involved in the transaction, and provide flexible business rules governing the flow of funds between those parties.

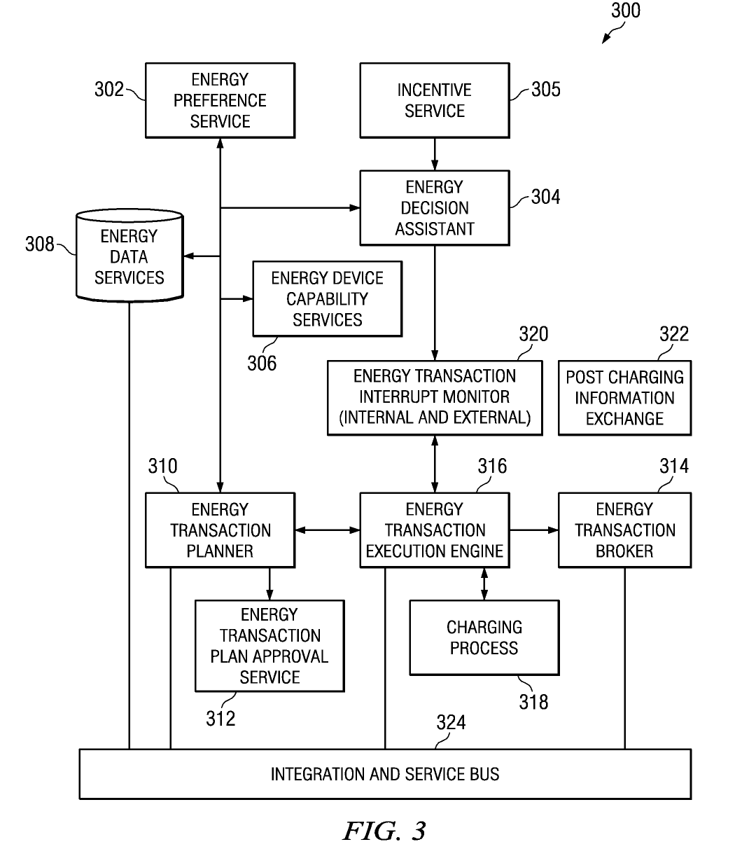

FIG. 3 is a block diagram of an energy transaction infrastructure in accordance with an illustrative embodiment. Electric vehicle energy transaction infrastructure 300 is a charging infrastructure for managing all phases of an electric vehicle charging transaction. During the pre-charge phase, all parties of the transaction are presented with the conditions governing the charging transaction. The parties may include, without limitation, the owner of the electric vehicle to be charged, the operator of the electric vehicle, the owner of the charging station, and an electric utility company providing electricity to an electric power grid associated with the charging station. Parties agree to conditions relevant to their role in the transaction prior to the charge commencing. There are likely to be many special circumstances in the terms and conditions which are presented in standard formats which are universally understood and which can be readily communicated and agreed upon by all parties.

During the pre-charge phase, electric vehicle energy transaction infrastructure 300 may utilize energy preference service 302, energy decision assistant 304, incentive service 305, energy device capability services 306, energy data services 308, energy transaction planner 310, and/or energy transaction plan approval service 312 to generate a plan governing the charging transaction for the parties involved in the transaction.

Energy preference service 302 is a software component that generates, stores, and retrieves preference information associated with an electric vehicle and the preference information associated with the parties to the transaction. Preferences may include, without limitation, a maximum price per kilowatt hour of electricity to be paid by a party, a location where charging may occur, a location where charging may not occur, a rate of charging the electric vehicle, a minimum amount of charge, or any other preferences associated with charging an electric vehicle. The preferences may be pre-generated by one or more of the parties to the transaction.

Energy decision assistant 304 is an optional service that provides real-time options and trade-offs for a particular trip. For example, energy decision assistant 304 may monitor available incentives, weather conditions, a travel route, traffic information, and other real-time data to identify the best electric vehicle charging options for a particular trip.

Incentive service 305 receives offers of incentives from third party vendors. The incentives may be offers of discounts, rebates, rewards, and/or other incentives associated with charging an electric vehicle to encourage an operator of the electric vehicle to perform one or more behaviors associated with charging the electric vehicle. For example, and without limitation, an incentive may offer to charge the electric vehicle for free at a particular charging station if the owner or operator of the electric vehicle purchases one or more products from the third party vendor. Incentives service 305 provides information describing current incentives to energy transaction planner 310. In one embodiment, incentives service 305 provides the information describing the incentives to energy decision assistant 304. Energy decision assistant 304 then provides the incentives information to energy transaction planner 310.

Energy device capability service 306 is a software component that identifies and validates device capabilities. For example, and without limitation, energy device capability service 306 may include information describing the charging capabilities of the charging station, the charging requirements of the electric vehicle, the maximum storage capacity of the electric vehicle on-vehicle storage mechanisms, the existing amount of charge in the electric vehicle, the number of amps of electricity the charging station is capable of providing, and any other information associated with the capabilities and requirements of the electric vehicles and the charging station.

Energy data services 308 are a set of one or more third party data sources providing information relevant to the energy transaction. Energy data services 308 may include, without limitation, weather information sources, traffic information sources, map and travel information sources, charging station price information sources, or any other third party information sources.

Energy transaction planner 310 is an application that creates a transaction plan for governing the electric vehicle charging transaction based on preferences of one or more principals. Energy transaction plan approval service 312 approves the transaction plan and validates with energy transaction broker 314. Energy transaction plan approval service 312 may be required to notify one or more parties of the terms of the transaction and obtain approval of one or more of the terms from the party. For example, and without limitation, if an operator of the electric vehicle is not the owner of the electric vehicle, energy transaction plan approval service 312 may require approval from the owner of the vehicle before allowing the vehicle to receive power at a charging station if the charging station and/or a utility will charge the owner of the electric vehicle a fee for the charging transaction. A utility refers to a provider of electric power. A utility typically provides electric power to a charging station via an electric power grid.

In this example, the charging phase begins when energy transaction execution engine 316 sends the transaction plan generated by energy transaction planner 310 for approval by energy transaction plan approval service 312, initiates the request to begin charging the electric vehicle, monitors and logs the health and safety of charging process 318, and receives requests from energy transaction interrupt monitor 320. During charging process 318, electricity flows into the electric vehicle or out of the electric vehicle and back into the power grid. Energy transaction interrupt monitor 320 monitors data transmissions to detect interrupt conditions that may terminate the flow of electric power to or from a vehicle. The interrupts may originate from the power grid, suppliers, and/or vehicles. For example, if a price of energy exceeds a predefined threshold in violation of a user-selected preference, energy transaction interrupt monitor 320 detects this interrupt condition and initiates appropriate actions to handle the cessation of electric power flow to the electric vehicle.

Energy transaction broker 314 supports settling an electric vehicle charging and discharge transaction independent of electricity supplier, parking space supplier, electrical infrastructure supplier, taxing authority, incentive provider, or other interested party. Elements include pricing schedules, time based pricing, facility recovery, tax collection, incentives, and/or fixed plans. Energy transaction broker 314 may also be used by energy transaction approval service 312 to validate the financial elements of the energy transaction plan prior to plan approval and prior to charging the electric vehicle.

The post-charge phase comprises analysis of the completed energy transaction to provide incentives, redeem credits or benefits, and induce specific behaviors by one or more parties involved in the charging transaction. The post-charge phase also includes payment of the appropriate parties for the energy transaction in accordance with the energy transaction plan governing the transaction. Various programs may be available to incent/encourage specific behaviors on the part of consumers. For example, a vehicle owner or user may receive reduced electricity rates if vehicle charging is conducted during off-peak times, such as during the night rather than during daylight hours when electricity usage is higher. Post charging information exchange 322 accumulates data pertinent to these incentives or redemption programs, authenticates the incentives data, and analyzes the incentives data to identify the most effective business process and optimize incentives for the parties.

During this charging phase, payment or fees for the charge are also recorded. Operational and financial parameters are conveyed for an optimum charge to occur. For example, a dynamic representation of an electric vehicle capability to consume charge should be understood at all times during the charging process to ensure the vehicle is not damaged or that the protections of the charging system are preserved. Electricity metering of the power flow may also be conducted and reported. Standards representing the acceptable charging voltage and amperage ranges, for example may be communicated and maintained for a safe charging transaction to occur. All data pertinent to the financial transaction is conveyed and recorded.

In one embodiment, a party that will be responsible for paying for electricity as an element of an electric vehicle charging transaction. An on-vehicle receiver maintains the data required to complete the electric vehicle charging transaction. The electric vehicle charging transaction comprises identifying at least one party paying the electric vehicle charge, the vehicle to be charged, and the relationship between the party and the electric vehicle. For example, the relationship between the party and the electric vehicle may be an owner of the electric vehicle, an operator of the electric vehicle, a renter of the electric vehicle, a utility associated with the electric vehicle, or any other relationship. Once the relationship is established, the charging of the storage mechanisms on the electric vehicle is performed.

The components shown in FIG. 3 may be implemented on a data processing system associated with an electric vehicle. In such case, the components communicate and transfer data using integration and service bus 324. Integration and service bus 324 is an internal communication system within the electric vehicle, such as any wired or wireless communications system. A wired communications system includes, without limitation, a data bus or a universal serial bus (USB). If one or more components shown in FIG. 3 are located remotely, the components may transfer data using any type of wired or wireless network connection to connect to a network, such as network 102 in FIG. 1. A wireless network connection may be implemented over a cell-phone network, satellite, two-way radio, Wi-Fi networks, or any other type of wireless network.

The process of inputting preferences into energy preference service 302 may be quite complex and require sophisticated user interface that may not be economically feasible to instantiate on all devices that may contain a preference service. For example, a vehicle preference service located on an electric vehicle may have limited input/output components. The illustrative embodiments recognize that there is a need for a system that allows for complex input processes for the principal to create electric vehicle charging preferences using a primary preference service on a computing device that is located remotely from the electric vehicle, a removable data storage device for providing the preferences to a vehicle preference service on the electric vehicle, and/or a network interface for transferring the preferences from the remote computing device where the preferences are created to the electric vehicle for storage on the electric vehicle.

The illustrative embodiments also recognize that preferences for an identified principal may be stored on a preference service that is located on a remote computing device to which the energy transaction planner does not have access. The illustrative embodiments recognize that a means for permitting the primary preference service of the principal to make preferences available to the energy transaction planner is also needed.

According to one embodiment of the present invention, a computer implemented method, apparatus, and computer usable program product for managing user preferences on remote computing devices for utilization in electric vehicle charging transactions is provided. A first preference service on a first computing device receives a request for a set of preferences for an identified principal from an energy transaction planner. A principal may be, without limitation, an electric vehicle owner, the electric vehicle operator, one or more electric power utilities, one or more financial institutions, one or more owners and/or operators of a charging station, a third party broker, or any other entity having an interest in the charging transaction.

In response to a determination that the set of preferences for the identified principal are unavailable on a first data storage device associated with the first computing device, the first preference service makes a determination as to whether the set of preferences are available on a removable data storage medium that is accessible by the first preference service or available on a second data storage device associated with a second preference service on a second computing device.

The removable data storage medium may be any type of removable data storage, such as, without limitation, a flash memory or a memory stick. A computing device may be any type of computing device, including, without limitation, a personal digital assistant (PDA), a laptop, a cellular telephone, a desktop computer, a tablet PC, or any other type of computing device.

A preference specifies a parameter of an electric vehicle charging transaction that is to be minimized, maximized, or optimized. A parameter of the charging transaction is any feature of the charging transaction, such as, without limitation, a rate of charging, a length of time for charging, a time to begin charging, a time to cease charging, a maximum level of charge, a minimum level of charge, or any other aspect of the charging transaction.

It will be appreciated by one skilled in the art that the words “optimize”, “optimization” and related terms are terms of art that refer to improvements in speed, efficiency, accuracy, quality, and/or improvement of one or more parameters of electric vehicle charging transactions, and do not purport to indicate that any parameter of the charging transaction has achieved, or is capable of achieving, an “optimal” or perfectly speedy, perfectly efficient, and/or completely optimized state.

In response to a determination that the set of preferences for the identified principal are available on the removable data storage medium, the first preference service retrieves the set of preferences stored on the removable data storage medium. The set of preferences is a set of one or more preferences selected or created by the identified principal.

In response to a determination that the preferences for the identified principal are stored on a second computing device associated with a second preference service, the first preference service sends a request for the set of preferences to the second preference service using a network connection. The second preference service retrieves the set of preferences. The second preference service sends the set of preferences to the first preference service. The first preference service receives the set of preferences from the second preference service. In response to receiving the set of preferences either from the removable data storage medium or from the second preference service, the first preference service sends the set of preferences to the energy transaction planner for utilization in managing the electric vehicle charging transaction. The first preference service is a proxy for the energy transaction planner and the second preference service.

In this example, the first preferences service is located on a computing device that may have a somewhat limited user interface. For example, the first preference service may be a vehicle preference service located on-board the electric vehicle. In such a case, the second preference service acts as a primary preference service located on a computing device that is remote from or located separately from the electric vehicle. The second computing device may be a mobile computer, such as a personal digital assistant or laptop computer. The second computing device may also include a desktop computer or any other type of client device. The second computing device may provide a more sophisticated or user-friendly input/output interface than might be available on-board the electric vehicle.

For example, in one embodiment, the second preference service located on the second computing device prompts the identified principal to enter preference selections using a user input/output interface on the second computing device. The second preference service receives the preferences selected by the principal to form selected preferences for the identified principal. The second preference service stores the selected preferences in the second data storage device located locally to the second preference service on the second computing device. The second data storage device is inaccessible to the first preference service and the energy transaction planner. Therefore, the second preference service either stores the set of preferences on a removable data storage device that may be plugged into the first computing device to give the first preference service access to the set of preferences or the second preference service transmits the set of preferences tot eh first preference service over a wired or wireless network connection.

In this embodiment, the set of preferences are either retrieved by the first preference service from the removable data storage device on-demand or by requesting transmission of the set of preferences from the second preference service. In this manner, the preferences created by a user on a computing device that is remote from the electric vehicle and/or the vehicle preference service are made available to the vehicle preference service on-demand. Non-regular users may also use this method to create and provide preferences to the vehicle preference service on-demand.

In another embodiment, a computer implemented method is provided for managing preferences for managing charging transactions for electric vehicles by a primary preference service. The primary preference service receives an identification of a principal associated with a client computing device by a primary preference service using a user interface at the first computing device. The principal is an entity having an interest in an electric vehicle charging transaction. The charging transaction is a transaction associated with at least one of charging an electric vehicle, storing electric power in an electric storage mechanism associated with the electric vehicle, and de-charging the electric vehicle. The primary preference service receives a selection of preferences from the principal to form a set of preferences for the principal. The primary preference service stores the set of preferences on the removable data storage device in response to receiving a selection to store the set of preferences on a removable data storage device and determining that the first primary preference service has access to the removable data storage device. The principal removes the removable data storage device having the set of preferences stored thereon and plugs the removable data storage device into a second data storage device associated with a vehicle preference service. The vehicle preference service copies the set of preferences from the removable data storage device onto a local data storage device associated with the second computing device.

In response to receiving a selection to transmit the set of preferences to the vehicle preference service over a network interface, the primary preference service identifies a location of the vehicle preference service and sending the set of preferences to the vehicle preference service. For example, the primary preference service may request the uniform resource locator (URL), host address, or telephone number of the vehicle preference service. The vehicle preference service saves the set of preferences for the principal onto the local data storage device associated with the second computing device for utilization in managing electric vehicle charging transactions associated with the principal.

In this manner the removable medium is used as a means to provide a better user-interface to input user preferences than might otherwise be available to the vehicle preference service on-board the electric vehicle. The removable medium provides a means to transport the preferences from the second computing device associated with the primary preference service to the computing device located on-board the electric vehicle and associated with the vehicle preference service.

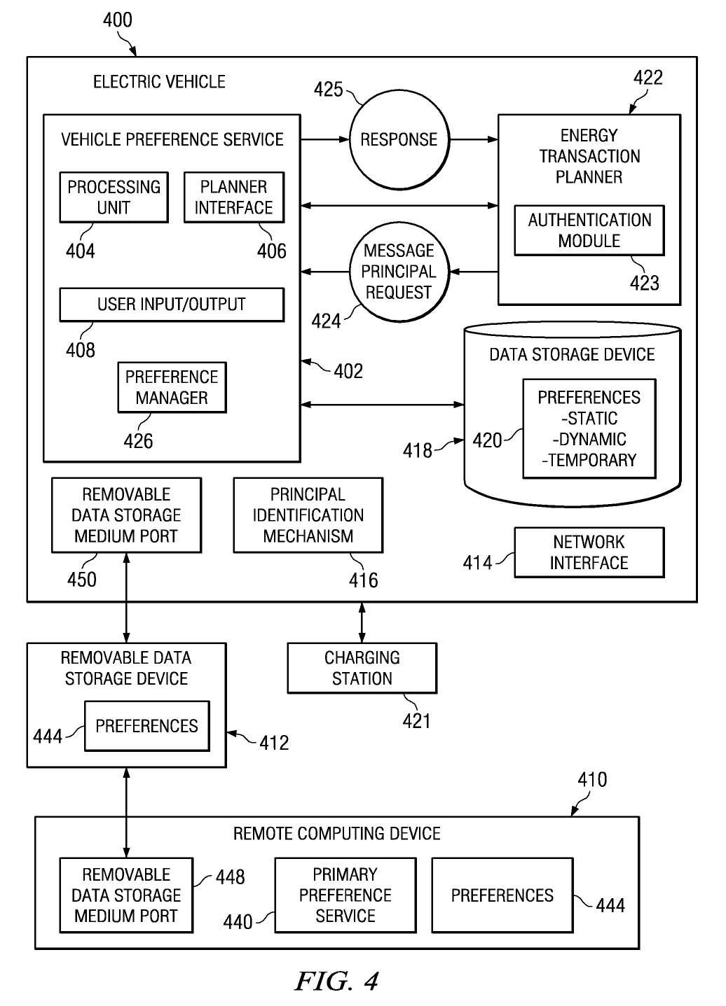

Turning now to FIG. 4, a block diagram of a vehicle preference managing system associated with an electric vehicle is shown in accordance with an illustrative embodiment. Electric vehicle 400 is an electric vehicle that relies in whole or in part on electricity to drive the vehicle, such as, without limitation, electric vehicle 116 in FIG. 1. Electric vehicle 400 contains an electric storage mechanism, such as a set of one or more batteries, to store electricity until the electricity is needed to power electric vehicle 400.

Vehicle preference service 402 is a software component for creating, managing, storing, and retrieving preferences for electric vehicle 400 and one or more parties associated with a charging transaction for the electric vehicle, such as energy preference service 302 in FIG. 3. In this example, vehicle preference service 402 is included within or bolted on electric vehicle 400. In other words, vehicle preference service 402 is a preference service that is included within electric vehicle 400 and manages preferences for one or more principals associated with electric vehicle 400. A principal may be an owner of electric vehicle 400, an operator of electric vehicle 400, an owner or operator of a charging station, a utility, a financial institution, or any other party having an interest in the electric vehicle charging transaction.

In one embodiment, vehicle preference service 402 is a system incorporated within electric vehicle 400 at the time of manufacture. In another embodiment, vehicle preference service 402 is added onto electric vehicle 400 as an after-market component. For example, and without limitation, vehicle preference service 402 may be added onto electric vehicle 400 as an add-on in a manner similar to the way in which global position system (GPS) navigation systems may be added on to vehicles.

Vehicle preference service 402 comprises processing unit 404, planner interface 406, and user input/output 408. Processing unit 404 provides the overall coordination of the components associated with vehicle preference service 402. Vehicle preference service 402 responds to user input and requests or prompts users to enter input through user input/output 408. User input/output 408 may be implemented in any type of user interface for receiving user input and providing output to the user, such as, without limitation, a graphical user interface, a command line interface, a menu driven interface, a keyboard, a mouse, a touch screen, a voice-recognition system, or any other type of input/output device.

The principal may enter preference choices as input through user input/output 408. In this example, the user utilizes user input/output 408 to create preferences using on-board vehicle preference service 402. However, in another embodiment, a user uses an input/output interface at a remote computing device, such as remote computing device 410, to create preferences. In such a case, the preferences created at remote computing device 410 may be transferred to vehicle preference service 402 using either removable data storage medium 412 or by sending the preferences to vehicle preference service using network interface 414 to establish a network connection between vehicle preference service 402 and the remote computing device. This embodiment is discussed in greater detail below.

Vehicle preference service 402 requests an identity of a principal associated with electric vehicle 400. Vehicle preference service 402 may use principal identification mechanism 416 to identify the principal. For example, vehicle preference service 402 may use principal identification mechanism 416 to identify the principal that created and/or updated the set of preferences so that the correct set of preferences may later be retrieved when a request for those preferences are requested. In other words, principal identification mechanism 416 authenticates users of the preference service who request input/access to their preferences, for example, and without limitation, to initiate a planning phase.

Principal identification mechanism 416 may include a badge reader, a radio frequency identification tag reader, a biometric device, a prompt requesting a password and/or user login, or any other type of identification mechanism. The biometric device may include, without limitation, a fingerprint scanner, a thumbprint scanner, a palm scanner, a voice print analysis tool, a retina scanner, an iris scanner, a device for reading deoxyribonucleic acid (DNA) patterns of the user, or any other type of biometric identification device.

Likewise, the identification of the user may include, without limitation, a user name, a password, a personal identification (PIN) number, an identifier, a fingerprint, a thumbprint, a retinal scan, an iris scan, or any other type of identification. The identification is associated with the set of preferences to map the set of preferences with the identification of the user that created the set of preferences. In another embodiment, security authentication, authorization, and/or identification information for the principal's identity may also be provided.

If the identity of the principal indicates that the principal is a new user, vehicle preference service 402 sends one or more requests to the principal to prompt the principal to select a set of preferences for the principal. The requests are sent to the principal through user input/output 408. The principal enters preference choices as input through user input/output 408. Vehicle preference service 402 stores the preference choices selected by the principal in data storage device 418 as a set of preferences in preferences 420. Preferences 420 may include preferences for a single principal or preferences for two or more principals. In one embodiment, if the principal is not a new user and pre-existing preferences are available for the user, vehicle preference service 402 displays the pre-existing, pre-selected preferences to the principal and gives the principal an opportunity to update or change one or more of the preferences that the principal previously selected.

Preferences 420 are choices for managing, governing, and controlling the manner in which electric vehicle 400 is charged at charging station 421. A preference specifies a parameter of the charging transaction that is to be minimized, maximized, or optimized. Each preference may be associated with a weighting value. For example, a preference may specify that charging at charging stations that obtain power from environmentally friendly, “green”, wind farms is to be maximized while charging at charging stations that obtain power from “brown”, coal powered plants that may be harmful to the environment and should be minimized. Brown energy refers to power generated from polluting sources, as opposed to green energy that is produced from renewable or less polluting energy sources.

Preferences 420 may also specify the price per kilowatt hour the user is willing to pay to charge the electric vehicle, identify certain charging stations the user prefers to fully charge electric vehicle 400 and identify other charging stations at which the user prefers to partially charge electric vehicle 400, perhaps due to proximity to the user's home or due to the source of the electricity used by charging station 421. For example, preferences may indicate that charging when the price per kilowatt hour is less than thirteen cents is to be maximized and charging when prices are higher than thirteen cents per kilowatt hour is to be minimized or prohibited all together. In another example, preferences 420 may specify a limit, such as, without limitation, buy electricity up to a certain price or optimize the cost of the return trip home given the current prices of gas and electricity.

Preferences 420 may be static, dynamic, or temporary preferences. A static preference is a preference that is effective until the user changes the preference. A static preference may be referred to as a default preference. A dynamic preference is a preference that does not have a predetermined value. A dynamic preference requires a user to enter a value for the dynamic preference in real time as the set of preferences responsive to the request of energy transaction planner 422. Thus, if a preference for the operator of the vehicle charging electric vehicle 400 is a dynamic preference, the principal is always prompted to enter a preference value indicating whether a particular operator of electric vehicle 400 is authorized to charge the electric vehicle. An user may choose to set a vehicle charging preference as a dynamic preference so that the owner of electric vehicle 400 will always be informed of who is attempting to charge electric vehicle 400 and have the option of preventing the charging of electric vehicle 400 in real time prior to commencing of the charging transaction.

A temporary preference is a preference that is only valid under certain conditions. The conditions may include, without limitation, a specified number of transactions, a predetermined period of time, or any other conditions. For example, if a condition is a specified period of time, when the period of time expires, the temporary preference is invalid and no longer used. For example, a user may set a temporary preference that indicates no charging is to be performed for the next ten minutes at the charging station where the user is parked because the user is only going to be parked for five minutes. At the end of the ten minute time period, the temporary preference expires and electric vehicle 400 can begin charging if the electric vehicle 400 is still parked at the charging station.

Vehicle preference service 402 may store preferences 420 in any type of storage component, such as data storage device 418. Data storage device 418 may be implemented as any type of known or available device for storing data, such as, without limitation, a hard drive, a flash memory, a main memory, read only memory (ROM), a random access memory (RAM), a magnetic or optical disk drive, tape, or any other type of data storage device. Data storage may be implemented in a single data storage device or a plurality of data storage devices. Data storage device 418 is located locally on electric vehicle 400.

Preferences 420 are preferences selections chosen by one or more users. A set of preferences may be stored for each user in a plurality of principals. For example, if electric vehicle 400 is owned and operated by a single person, preferences 420 may only contain a set of preferences for the one person that is the owner and operator. However, if electric vehicle 400 is owned by a company that frequently loans electric vehicles to employees, preferences 420 may include a set of preferences for the owner and a set of preferences for each employee that borrows electric vehicle 400. In such a case, vehicle preference service 402 may create, store, and manage hundreds of sets of preferences for hundreds of principals.

Vehicle preference service 402 receives requests from energy transaction planner 422 and responds to the requests from energy transaction planner 422 through planner interface 406. Planner interface 406 provides the necessary communication protocols and mechanisms to permit vehicle preference service 402 to communicate with energy transaction planner 422. Energy transaction planner 422 is a component for generating an energy transaction plan to manage the charging of an electric vehicle connected to an electric grid at charging station 421 in accordance with the preferences of one or more parties to the electric vehicle charging transaction, such as energy transaction planner 310 in FIG. 3.

Energy transaction planner 422 is a component for generating an energy transaction plan to manage the charging of an electric vehicle connected to an electric grid in accordance with the preferences of one or more parties to the electric vehicle charging transaction, such as energy transaction planner 310 in FIG. 3. When energy transaction planner 422 is engaged to create a transaction plan to govern an electric vehicle charging transaction for electric vehicle 400, energy transaction planner 422 sends message 424 through planner interface 406 to vehicle preference service 402. Message 424 contains at least the identity one or more principals and a description of the specific preferences that are required by energy transaction planner 422. For example, energy transaction planner 422 may only need charging related preferences if the charging station is incapable of providing discharge or store services. Message 424 may be implemented as a single message including the identification of one or more principals and an identification of the types of preferences of interest for the energy transaction or two or more messages exchanged between energy transaction planner 422 and vehicle preference service 402.

Energy transaction planner 422 may include authentication module 423. Authentication module 423 comprises any type of known or available encryption technology and/or security protocols. Authentication module 423 authenticates and/or encrypts communications between vehicle preference service 402 and energy transaction planner 422. Authentication module 423 may be used to authenticate vehicle preference service 402 itself or authenticate tokens provided by vehicle preference service 402 for each of the principals for which vehicle preference service 402 is providing preferences to energy transaction planner 423. Authentication module 423 may also be used to authenticate information received from vehicle preference service 402 in response 425.

In response to receiving message 424, vehicle preference service 402 retrieves the one or more preferences from the plurality of preferences stored in preferences 420 in data storage device 418 for the principal identified in message 424. Preference manager 426 is a software component associated with vehicle preference service. Preference manager 426 identifies specific preferences in preferences 420 that are responsive to the request in message 424. Preference manager 426 retrieves the preferences that are responsive to the request for the identified user to form a set of preferences. The set of preferences are sent to energy transaction planner 422 via response 425 for utilization in generating an energy transaction plan. In other words, response 425 comprises the set of preferences that are responsive to the request in message 424. Energy transaction planner 422 generates an energy transaction plan based on the set of preferences. The energy transaction plan is used to govern the charging of electric vehicle 400 at charging station 421. Charging station 421 is a station or kiosk for permitting electric vehicle 400 to connect to an electric grid to charge or de-charge electric storage mechanisms and/or to power electric vehicle 400, such as charging station 118 in FIG. 1.

The principal may need to store and make available electric vehicle charging preferences for utilization by energy transaction planner 422. The principal uses on-board vehicle preference service 402 to maintain, input, store, and/or retrieve preferences 420 for the principal and/or one or more other parties associated with the electric vehicle charging transaction, such as, without limitation, a electric utility of the owner, an electric utility of the operator, the charging station, the electric vehicle manufacturer, the electric vehicle distributor, or any other party with an interest in the electric vehicle charging transaction.

In the example shown in FIG. 4, energy transaction planner 422 is an on-vehicle component that is attached, coupled to, or located on electric vehicle 400. However, in another embodiment, vehicle preference service 402 may receive message 424 from an energy transaction planner that is located on a computing device that is remote from electric vehicle 400, such as remote computing device 410. The remote energy transaction planner sends a message with an identification of one or more principals and a request for preferences of interest to vehicle preference service 402 over a network via network interface 414.

Network interface 414 is any type of network access software known or available for allowing electric vehicle 400 to access a network. Network interface 414 connects to a network connection, such as network 102 in FIG. 1. The network connection permits access to any type of network, such as a local area network (LAN), a wide area network (WAN), or the Internet. Vehicle preference service 402 utilizes network interface 414 to send the set of preferences to off-vehicle energy transaction planner 430 that is located on a remote computing device.

In this example, preferences 420 include preferences for an owner and/or operator of electric vehicle 400. In another embodiment, preferences 420 may also include preferences for principals other than the owner and/or operator of electric vehicle 400. For example, a principal may also include an owner or operator of charging station 421, a utility, a financial institution, or any other party having an interest in the electric vehicle charging transaction. The non-owner or operator principals may have their preferences entered into the on-vehicle preference service by the owner or operator of electric vehicle 400 on their behalf.

The process on inputting preferences may be quite complex and require sophisticated user interface that may not be economically feasible to instantiate on all devices that may contain a preference service, such as vehicle preference service 402 on electric vehicle 400. In other words, vehicle preference service 402 may have limited input/output components. In addition, preferences 420 stored on electric vehicle 400 may not include preferences for all principals. For example, vehicle preference service 402 may not include preferences for a current operator of electric vehicle 400 that is borrowing or renting electric vehicle 400 for the weekend.

In such cases, the principal may have already created preferences on a computing device that is not located on electric vehicle 400, such as, but not limited to, a PDA or laptop computer. In addition, the principal may prefer to create preferences on a computing device that has better input/output components and/or a computing device with which the principal is more familiar.

Primary preference service 440 is a preference service on remote computing device 410 that provides a user interface to the principal to permit the principal to compose or update the principal's preferences, such as energy preference service 302 in FIG. 3. Remote computing device 410 may be any type of computing device that is not coupled to electric vehicle 400, such as, without limitation, a personal digital assistant (PDA), a laptop computer, a tablet PC, a desktop computer, a cellular telephone, or any other type of computing device. Preferences 444 includes electric vehicle charging preferences selected by the principal.

The principal transfers preferences 444 from remote computing device 410 to electric vehicle 400 by saving preferences 444 onto removable data storage medium 412. Removable data storage medium 412 is a removable data storage device, such as, without limitation, a universal serial bus (USB) memory stick, a flash memory card, a secure digital (SD) memory card, an optical disk, or a magnetic disk. Preferences 444 stored on remote computing device are copied or transferred onto removable data storage medium 412 by plugging removable data storage medium 412 into removable data storage medium port 448. Removable data storage medium port 448 is a slot or interface for connecting removable data storage medium 412 to remote computing device 410. In other words, removable data storage medium port 448 is a physical interface on remote computing device 410 that can accommodate removable data storage medium 412.

Thus, preferences 444 are input onto remote computing device 410 by the principal. The principal runs the computer program associated with primary preference service 440 and based on input requests and response, the principal inputs preferences for the principal to the program. The principal inserts a compatible removable medium, such as removable data storage medium 412, into the physical interface removable data storage medium port 448 on remote computing device 410. The program stores preferences 444 on removable data storage medium 412. The program may also store identification information associated with the principal on removable data storage medium 412. The identification information is information such as, without limitation, a user name, a password, a personal identification (PIN) number, an identifier, a fingerprint, a thumbprint, a retinal scan, an iris scan, or any other type of identification.

Once preferences 444 are stored, the principal can eject removable data storage medium 412 from remote computing device 410 and insert removable data storage medium 412 into removable data storage medium port 448 on electric vehicle 400. Removable data storage medium port 448 is a physical interface, such as a slot or port. Removable data storage medium port 448 is located on electric vehicle 400 and is compatible with removable data storage medium 412.

When removable data storage medium 412 having preferences 444 is plugged into electric vehicle 400, vehicle preference service 402 either copies preferences 444 onto an internal storage component, such as data storage device 418, or vehicle preference service 402 uses removable data storage medium 412 as part of the storage components of vehicle preference service 402. This makes the preferences of the identified principal available to energy transaction planner 422 on request. Thus, in this embodiment, preferences 444 are input into remote computing device 410 by a principal, stored on removable data storage medium 412 by primary preference service 440, and provided to vehicle preference service 402 by insertion of removable data storage medium 412 into removable data storage medium port 450 on electric vehicle 400.

In another embodiment, the use may direct the remote computing device 410 to transfer to the vehicle preference service 402 the preferences via network device 414 for permanent or semi-permanent storage in data storage device 418. In this way, the remote computing device provides the complex user interface and input/output capability not available in vehicle preference service 402 while still making the preferences easily available to the vehicle preference service 402 when requested by the energy transaction planner 422.

In this embodiment, primary preference service 440 is installed on remote computing device 410. However, in another embodiment, primary preference service 440 software may be installed on removable data storage device 412 rather than being installed on remote computing device 410. In this example, the principal plugs removable data storage medium 412 into remote computing device 410 prior to creating preferences 444. Once removable data storage medium 412 is plugged into remote computing device 410, primary preference service 440 installed on removable data storage device 412 may be used by the principal to create new preferences and/or update or modify existing preferences.

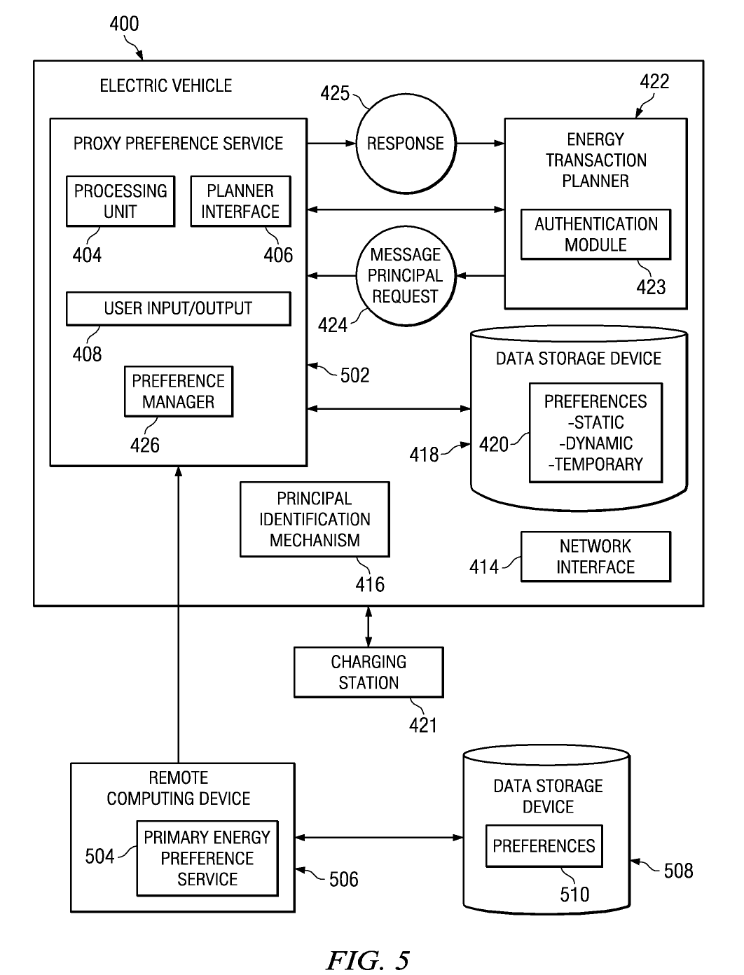

Turning now to FIG. 5, a block diagram of a proxy preference service and a primary preference service in accordance with an illustrative embodiment. FIG. 5 is an example illustrating electric vehicle 400 in FIG. 4 in which energy transaction planner 422 and proxy preference service 502 are co-located on electric vehicle 400. Proxy preference service 502 creates and maintains preferences 420 for one or more principals, such as the owner of electric vehicle 400 and/or regular operators of electric vehicle 400.

There may be times when a new principal operating electric vehicle 400 is identified or where another person or entity becomes a principal in a potential energy transaction involving electric vehicle 400. The preferences for the new principal may be managed and stored by primary energy preference service 504 located on remote computing device 506. In this embodiment, energy transaction planner 422 only has direct access to proxy preference service 502 located on electric vehicle 400. Energy transaction planner 422 does not have direct access to primary preference service 504 on remote computing device 506 on which preferences for the identified principal are stored.

Proxy preference service 502 is a preference service located on electric vehicle 400, such as vehicle preference service 402 in FIG. 4. Energy transaction planner 422 does have direct access to proxy preference service 502. Energy transaction planner 422 sends message 424 identifying the principal and requesting a set of preferences for the principal to proxy preference service 502. However, data storage device 418 associated with proxy preference service 502 does not contain preferences for the identified principal.

Primary energy preference service 504 is a software component for creating, storing, and managing preferences for a user. Primary energy preference service 504 is located on remote computing device 506. Remote computing device 506 may be any type of computing device that is not coupled to electric vehicle 400, such as, without limitation, a mobile computer, a personal digital assistant (PDA), a mobile computer, a laptop computer, a tablet PC, a desktop computer, a cellular telephone, or any other type of computing device.

The principal runs primary energy preference service 504 and based on input requests from primary energy preference service and the principal's responses input into the primary energy preference service, primary energy preference service creates preferences 510 for the principal. Primary energy preference service 504 stores preferences 510 on data storage device 508 that is accessible to primary energy preference service 504. In this example, remote computing device 506 and data storage device 508 are not accessible to energy transaction planner 422 on electric vehicle 400.

Preferences 510 for the identified principal are not directly available from proxy preference service 502, which is the preference service that is accessible to energy transaction planner 422. As such, energy transaction planner 422 cannot obtain the necessary preference data to create a transaction plan directly.

Proxy preference service 502 is a preference service that acts as a proxy on behalf of a principal in order to provide preferences 510 for the identified principal to energy transaction planner 422. Proxy preference service 502 includes a communications protocol to enable Proxy preference service 502 to securely request identification of the unknown principal. For example, proxy preference service 502 may request identification of the principal through any means by which proxy preference service 502 instantiates user input/output 408 component. Principal identification mechanism 416 may also be utilized to generate identification for the principal. Energy transaction planner 422 sends message 424 to proxy preference service 502 requesting preferences of interest. Message 424 may also include the identity of the principal.

Proxy preference service 502 uses the communications protocol, user input/output 408, and/or any other known or available means for requesting identification of primary energy preference service 504, request a location of primary energy preference service 504, and/or request communication channels of primary energy preference service 504. For example, proxy preference service 502 may request the uniform resource locator (URL), host address, or telephone number of primary energy preference service 504.

Proxy preference service 502 utilizes network interface 414 or any other known or available means to enable wired or wireless communications to communicate with primary energy preference service 504 over a network connection. For example, the network interface 414 may include WiFi, Bluetooth, cellular telephone, satellite communications, wireless network, or any other means for wireless communication. The wired communication may be enabled by, for example, and without limitation, when electric vehicle 400 is connected to charging station 421 before a charging transaction begins, this physical connection may include a means for network communication along with energy transfer, either through additional signal wires in the cabling or even by embedding network signals within the power wires. The network connection may also be created via a universal serial bus (USB) or other standard wired interface.

Proxy preference service 502 utilizes a secure communication protocol to identify Proxy preference service 502 to primary energy preference service 504. Primary energy preference service 504 also utilizes the secure communication protocol to identify itself to proxy preference service 502. Proxy preference service 502 sends the identity of the principal and the request for the preferences of interest to primary energy preference service 504 using the secure communication protocol. The preferences of interest are the preferences that are required for energy transaction planner 422 to generate an energy transaction plan for the proposed transaction. Primary energy preference service 504 retrieves the preferences of interest from preferences 510 for the principal and sends the preferences of interest to proxy preference service 502 using the secure communication protocol.

The preferences of interest may be sent to proxy preference service 502 in a form that is suitable for use by energy transaction planner 422. In another embodiment, the preferences of interest may not be sent to proxy preference service 502 in a form that is compatible with energy transaction planner. In such a case, proxy preference service 502 converts the preferences of interest from the form that is incompatible into a form that is compatible for use by energy transaction planner 422.

The security of the communication mechanism depends on the specific deployment requirements and may be implemented using known techniques. In this embodiment, the cross identification of proxy preference service 502 and primary energy preference service 504 is symmetrical. However, the cross identification may also be asymmetrical if one preference service has a trust relationship. For example, one preference service may be embodied on a transaction broker.

In another embodiment, energy transaction planner 422 may have a direct and trusted communication mechanism with a remote primary preference service, such as primary energy preference service 504. In this example, the owner and/or regular operators may create and store their preferences on this trusted remote primary preference service. When a new principal is identified that has created and/or stored preferences on a different remote computing device, primary energy preference service 504 may act as a proxy between energy transaction planner 422 and the different preference service on the different remote computing device. In other words, the proxy preference service is not required to be located on the same device and/or electric vehicle as energy transaction planner. The proxy preference service may also be located remotely from energy transaction planner.

In yet another embodiment, energy transaction planner 422 may not be located on electric vehicle 400. Instead, energy transaction planner 422 may be located on a remote computing device. In such a case, proxy preference service 502 may be located on the same remote computing device as energy transaction planner 422, proxy preference service 502 may be located on electric vehicle 400, or proxy preference service 502 may be located on a different remote computing device from energy transaction planner, electric vehicle 400, and primary energy preference service 504.

Thus, primary energy preference service 504 may transmit preferences 510 to proxy preference service 502 on-demand for utilization in a limited number of charging transactions or for utilization for a limited amount of time. In such a case, proxy preference service 502 may not store a copy of preference 510 on the local data storage device located on electric vehicle 400, such as data storage device 418. In another embodiment, although preferences 510 are created on remote computing device 506, once preferences 510 are received by proxy preference service 502, proxy preference service 502 stores a copy of preferences 510 on data storage device 418 on electric vehicle 400 for utilization in future charging transactions.

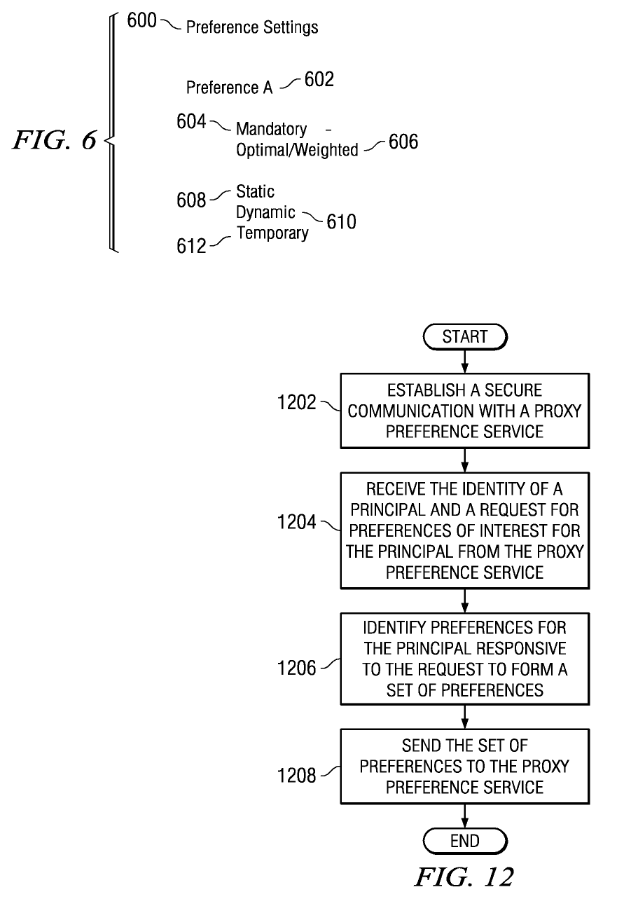

FIG. 6 is a block diagram of preference settings in accordance with an illustrative embodiment. Preference settings 600 are settings that may be appended to a preference, such as preference A 602. Preference A 602 may be any type of preference, such as, without limitation, financial, locations, time, amount of charge, power source, operator, or any other preferences. Mandatory 604 specifies that the requirements of a particular preference must be met or a charging transaction will not be permitted. For example, if a user sets an operator preference indicating that only the owner is permitted to charge the electric vehicle and the user sets the preference to mandatory, only the owner will be permitted to initiate charging of the electric vehicle. Any other operator of the electric vehicle will not be permitted to charge the electric vehicle unless the owner changes the preference settings.

Optional/weighted 606 is a setting that indicates that a preference is preferred or desirable, but not mandatory. For example, the user may specify that “green” power sources, such as wind and solar power sources, are preferred, but not mandatory. In such cases, the energy transaction planner may still permit charging of the electric vehicle at charging stations that utilize electricity provided by coal powered electric generators. The weighting value permits a user to indicate how strongly the user wants a particular preference to be minimized, maximized, or optimized. In the example above, the user may indicate a high weighting value in favor of wind and solar power, a medium weighting value for nuclear power plants, and a low weighting value for coal power plants. The energy transaction planner may then use the weighting value to determine how much to charge or de-charge the electric vehicle or whether to charge or de-charge the electric vehicle at all.

Static 608 indicates that a preference is a default preference that should be used in all cases. A static preference does not change from one charging transaction to the next charging transaction. Dynamic 610 setting indicates that a user wants to provide or select a value or choice for this preference every time a charging transaction plan is generated. A dynamic preference is selected in real time as the charging transaction is commencing. Temporary 612 indicates that a temporary preference value is to be used in place of a static preference for a limited period of time. For example, a user may wish to override a static preference that the electric vehicle should always be fully charged at a particular charging station with a temporary preference indicating that the electric vehicle is not to be charged because the user will only be parked at the charging station for a few minutes.

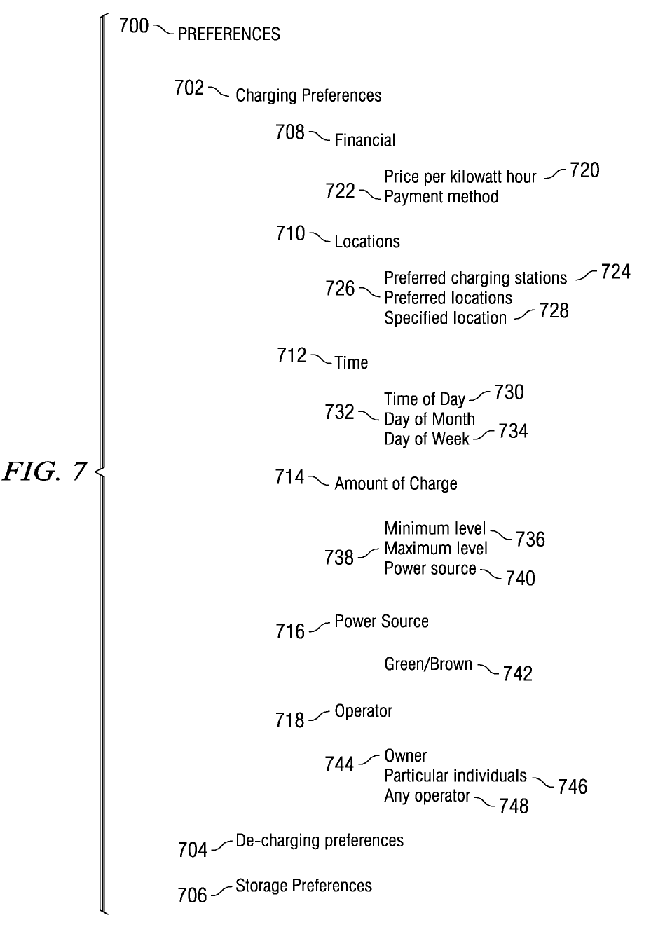

Referring to FIG. 7, a block diagram of electric vehicle charging preferences is shown in accordance with an illustrative embodiment. Preferences 700 are types of preferences that may be included within preferences for one or more users, such as preferences 420 in FIG. 4. Preferences 700 may be charging preferences 702 for governing energy transaction to charge an energy storage device associated with the electric vehicle, de-charging preferences 704 for governing energy transactions for de-charging or depleting the energy stored in an energy storage device, or storage preferences 706 for governing the storage of electricity in the electric vehicle's energy storage mechanisms.

A user may wish to de-charge or transfer power from the electric vehicle to a charging station if the price of the electricity is higher than when the electricity was purchased and stored in the electric vehicle. For example, if a user charges an electric vehicle at night when the price of the electricity is only nine cents per kilowatt hour, the user may wish to de-charge or provide electricity from the electric vehicle back to the charging station at noon when the price per kilowatt hour is fifteen cents because the user is able to make a profit from storing the electricity in the electric vehicle until the price of electricity increases and then selling the electricity back to the electric grid.

Some examples of charging preferences include, without limitation, financial 708, locations 710, time 712, amount of charge 714, power source 716, and/or operator 718. For example, financial 708 preferences may specify price per kilowatt hour 720 that the user is willing to pay to charge the electric vehicle or payment method 722 for purchasing the electricity from the charging station and/or the electricity grid. Payment method 722 may include, without limitation, credit cards, cash, debit card, credit, or any other type of payment. The payment type preferences may even specify a particular credit card or bank account for debit to pay for the charging transaction.

Locations 710 preferences may specify preferred charging station 724, preferred locations 720 of the charging stations, and/or specified locations 728 for charging. For example, the user may specify that any time the electric vehicle is parked at a charging station that is at a specified location, the electric vehicle is not to be charged at all, to be charged to a particular charge level, or to be fully charged. The user may wish to set these preferences because the charging stations are a given distance from the user's home or workplace, due to past service received at the charging station, or any other factors.

Time 712 preferences may specify, without limitation, time of day 730 for charging the vehicle, time of day to stop charging the vehicle, day of month 732 for charging, and/or day of the week 734 for charging the electric vehicle.

Amount of charge 714 preferences may specify minimum level 736 of charge in the electric vehicle's storage device, a maximum level of charge 738, or specify different levels of charge depending on power source 740 of the electricity used to charge the electric vehicle. If the power source is a “green” source, such as solar power, the user may specify a higher charge level than if the power source is a more environmentally harmful, or “brown” power source, such as coal or oil.

Power source 716 preferences specify types of power sources that are acceptable or preferred and/or provide weighting values for different power sources. The power sources may be identified as “green” or “brown” 742. The power sources may also be identified specifically by the type of power source, such as wind, solar, coal, oil, and so forth.

Operator 718 preferences are preferences for allowing particular operators to charge the electric vehicle. Owner 744 is a preference that permits an owner to charge, particular individuals 746 permits identified individuals to charge the vehicle, and any operator 748 is a preference that permits anyone to charge the electric vehicle. The operator 718 preference may permit a user to prevent or impede theft of the electric vehicle. For example, if a user sets owner 744 as a mandatory preference that only permits the owner to charge the electric vehicle, a thief would not be permitted to recharge the electric vehicle. Therefore, a thief may not be able to transport the electric vehicle very far from the location at which the electric vehicle was stolen.

The preferences described for charging preferences 702 are only examples of some preferences that may be used. A vehicle preference service is not required to utilize all of the preferences shown in FIG. 7. Moreover, a vehicle preference service may utilize other preferences not shown in FIG. 7 without departing from the scope of the embodiments. Finally, the preferences shown for charging preferences 702 may also be used as preferences for de-charging preferences 704 and/or storage preferences 706, in addition to other preferences not shown. For example, de-charging preferences 704 may include operator 718 preferences specifying operators that are permitted to de-charge or sell power back to the electric grid, financial 708 specifying prices at which the electricity may be transferred from the electric vehicle and sold back to the electric grid, time 712 when de-charging may occur, amount of charge 714 levels for de-charging, and power source 716 of the power that is de-charged.

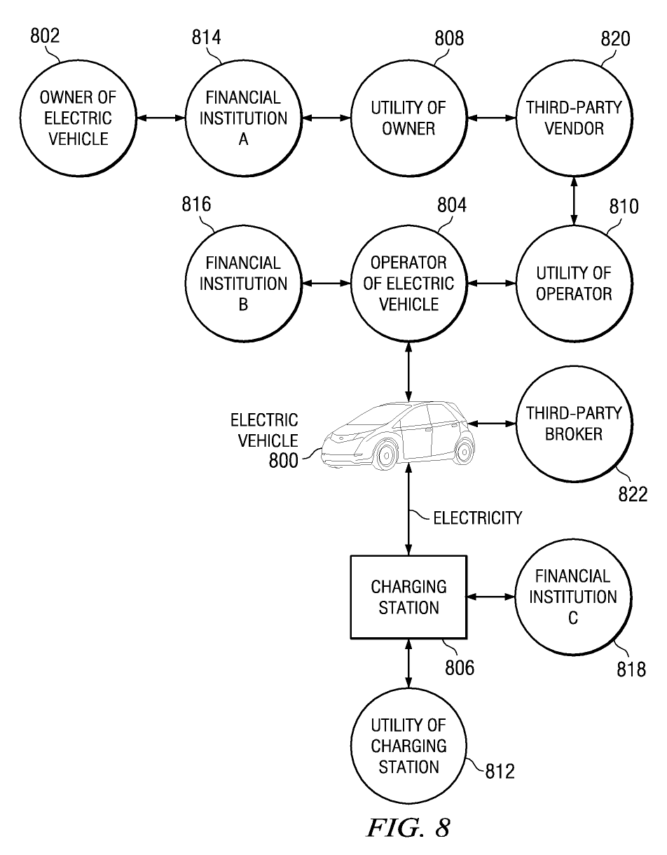

Turning now to FIG. 8, a block diagram of principals in an electric vehicle charging transaction is depicted in accordance with an illustrative embodiment. Each party may have a set of preferences for charging the electric vehicle that is managed by the vehicle preference service. A principal is any entity that may have an interest or role in the energy transaction for charging an electric vehicle, including but not limited to, the vehicle operator, owner of the electric vehicle, the owner of the charging station, the operator of the charging station, financial institutions associated with one or more of the parties, utilities associated with one or more of the principals, or third parties having an interest in the charging transaction. FIG. 8 illustrates the different relationships between principals. Any one or more of the principals shown in FIG. 8 may have preferences stored in the on-vehicle preference service.

Electric vehicle 800 is a vehicle that relies in whole or in part on electric power to drive the vehicle, such as electric vehicle 116 in FIG. 1 or electric vehicle 400 in FIG. 4. Owner of electric vehicle 802 is a principal that creates a set of preferences in vehicle preference service on electric vehicle 800. Operator of electric vehicle 804 is a principal that may be the owner or only someone that has borrowed electric vehicle 800. Each operator may optionally create their own set of preferences in the vehicle preference service on electric vehicle. Charging station 806 is a station or kiosk at which electric vehicle obtains charge or de-charges to provide electricity back to the electric grid, such as charging station 118 in FIG. 1 or charging station 421 in FIG. 4. Charging station 806 may also have a set of preferences for governing the charging of electric vehicle 800.

Each party may have a utility associated with the party. Each utility may also have preferences for governing the charging transaction. For example, utility of owner 808, utility of operator 810, and utility of charging station 812 may each be parties with an interest in the charging transaction and preferences for governing the charging of electric vehicle 800.

Each party may also have a financial institution for paying for the electricity purchased, or for being reimbursed for electricity provided back to the electric grid. A financial institution may be a bank, a credit card company, a broker, a lender, or any other financial institution. For example, financial institution A 814 may be associated with owner of electric vehicle 802, financial institution B 816 may be associated with operator of electric vehicle 804, and financial institution C 818 may be associated with charging station 806. Each of these financial institutions may have preferences for controlling how amounts due are received, how charges of payments are received and accepted, how credits are issued and received, and other aspects of financial transactions associated with charging electric vehicle 800.

Third party vendor 820 is a third party that is not associated with charging station 806 or electric vehicle 800. For example, and without limitation, third party vendor 820 may be a grocery store, a convenience store, a car wash, a repair shop, or any other type of vendor. Third party broker 822 is a third party that may provide financing or manage financial transactions associated with charging electric vehicle 800.

Each of the parties shown in FIG. 8 may optionally have preferences, constraints, limitations, or requirements associated with charging electric vehicle 800. The vehicle preference service on electric vehicle 800 may optionally store, manage, and retrieve some or all of these preferences, constraints, limitations, and requirements in data storage device on electric vehicle 800. The vehicle preference service retrieves the information of interest that is responsive to a request by an energy transaction planner and sends the preferences of interest to the energy transaction planner for use in generating a plan to govern the charging of electric vehicle 800 at charging station 806.

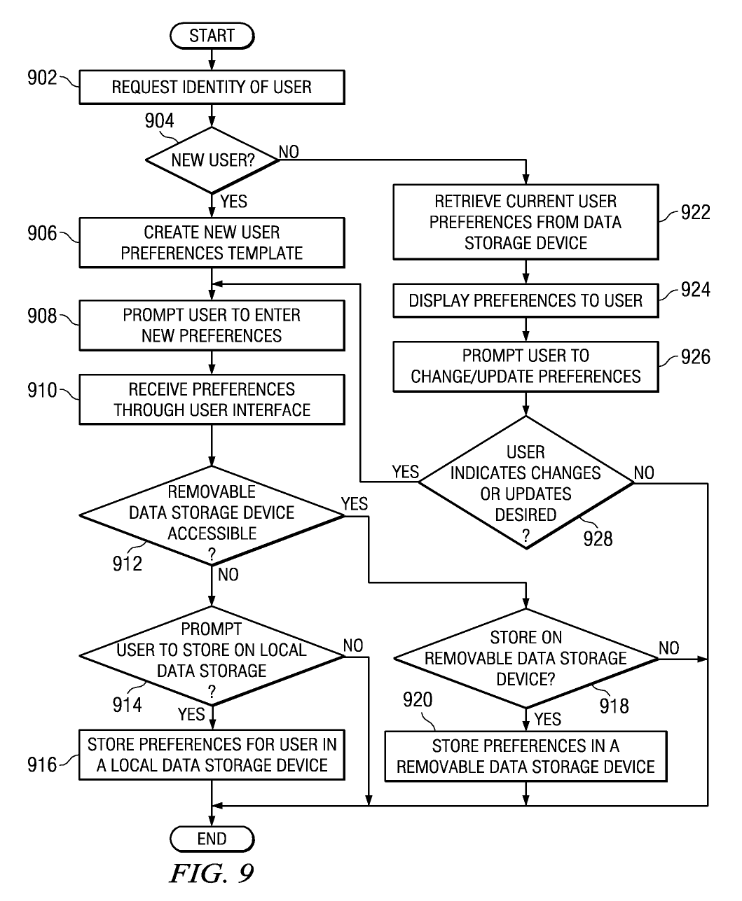

FIG. 9 is a flowchart illustrating a process for creating and storing preferences by a remote preference service in accordance with an illustrative embodiment. The process in FIG. 9 is implemented by an energy preference service on a computing device that is remote from an electric vehicle, such as primary preference service 440 in FIG. 4 or primary preference service 504 in FIG. 5.

The process begins by requesting an identity of a user (step 902). The user may be identified using any type of identification means, such as, without limitation, a user name, a password, a personal identification (PIN) number, an identifier, a fingerprint, a thumbprint, a retinal scan, an iris scan, or any other type of identification. The user may be an owner of an electric vehicle, an operator of the electric vehicle, a utility, a financial institution, an owner or operator of a charging station, a third party broker, or any other principal shown in FIG. 8.

The primary preference service makes a determination as to whether the user is a new user (step 904). If the user is a new user, the primary preference service creates a new preferences template (step 906). The primary preference service prompts the user to enter new preferences (step 908). The user may enter the preference selections through a user interface, such as user input/output 408 in FIG. 4.

The primary preference service receives the preferences through the interfaces (step 910). The primary preference service makes a determination as to whether a removable data storage device is accessible (step 912). If no removable data storage device is accessible, the primary preference service prompts the user to indicate whether to store the preferences on a local data storage device (step 914). In response to a selection to store on local data storage on the remote computing device, the preferences are stored on the local data storage device (step 916) with the process terminating thereafter.

Returning to step 912, if a removable data storage device is accessible, a determination is made as to whether to store preferences on a removable data storage device (step 918). In response to a user selection to store preferences on the removable data storage device, the preferences are stored on the removable data storage device (step 920) with the process terminating thereafter.

Returning to step 904, if the user is not a new user, the primary preference service retrieves current preferences for the user (step 922). The primary preference service displays the preferences to the user (step 924). The display may be a graphical or visual display, an audio display, a combination of audio and visual content, or any other type of presentation of the preferences to the user. The primary preference service prompts the user to indicate whether the user wants to enter changes or update the preferences (step 926). The primary preference service determines whether the user indicates changes or updates are desired (step 928).

If the user indicates that changes or updates are desired, the vehicle preference service prompts the user to enter new preferences (step 908). The primary preference service receives the updated preferences through the user interface (step 910). The preferences are updated or modified preferences. The primary preference service makes a determination as to whether a removable data storage device is accessible (step 912). If a removable data storage device is accessible, the primary preference service prompts the user to indicate whether the store the updated preferences on a local data storage device (step 914). In response to a selection to store updated preferences on local data storage on the remote computing device, the updated preferences are stored on the local data storage device (step 916) with the process terminating thereafter.

In another embodiment, the process in FIG. 9 may have additional branching paths (not shown) that prompt the user to determine if the preferences should be transferred to another preference service, such as the on-vehicle preference service 402 via a network connection established by a device such as, without limitation, network device 414 in FIG. 4.

This process in FIG. 9 permits a user to input their preferences directly into an on-vehicle preference service. This process also permits a user to store preferences for one or more other principals. For example, if the user is the owner of the electric vehicle, the user may wish to enter the user's own preferences and the preferences for the user's utility company and one or more frequent operators of the electric vehicle.

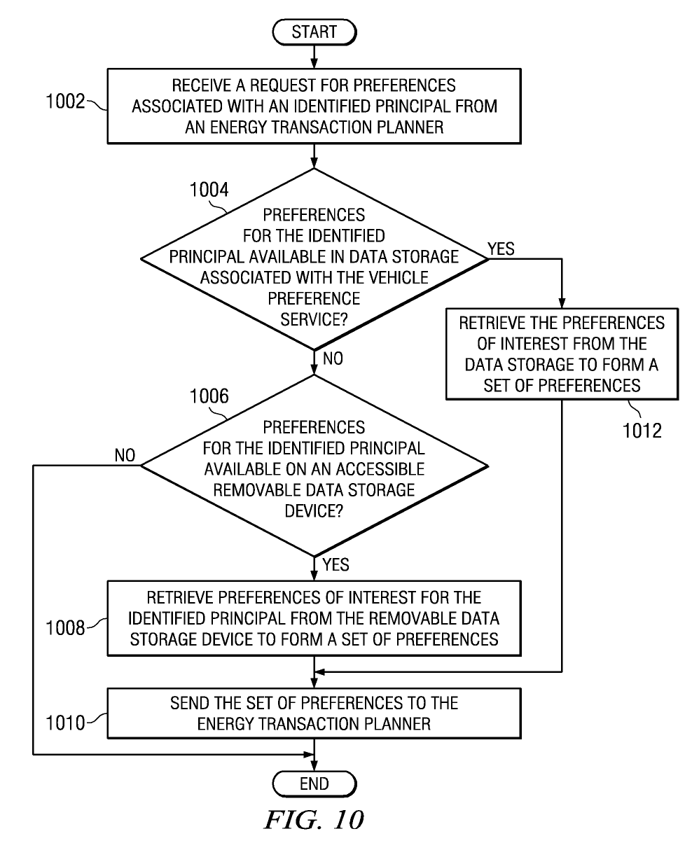

Turning now to FIG. 10, a flowchart illustrating a process for retrieving preferences for a principal from a removable data storage device is shown in accordance with an illustrative embodiment. The process in FIG. 10 is implemented by a proxy energy preference service on an electric vehicle, such as proxy preference service 402 in FIG. 4.

The process begins by receiving a request for preferences for an identified principal from an energy transaction planner, such as energy transaction planner 522 in FIG. 5 (step 1002). The preference service makes a determination as to whether preferences for the identified principal are available in the data storage associated with the vehicle preference service on the electric vehicle (step 1004). The preferences may not be available if the identified principal is a new driver of the electric vehicle or if the principal has saved their preferences in a data storage device on a remote computer, such as, without limitation, a cell phone, a personal digital assistant (PDA), a laptop computer, or a computer in the principal's home or workplace.

If the preferences are not available, the proxy preference service makes a determination as to whether the preferences for the identified principal are available on an accessible removable data storage device (step 1006). A removable data storage device is accessible if the removable data storage device is plugged into a port for the removable data storage device on the electric vehicle or is otherwise able to transmit data to the preference service on the electric vehicle. If the preferences are not available on an accessible removable data storage device, the process terminates thereafter.

Returning to step 1006, if preferences are available on an accessible removable data storage device, the preference service retrieves the preferences of interest for the identified principal that are responsive to the request from the removable data storage device to form a set of preferences (step 1008). The preference service sends the set of preferences to the energy transaction planner (step 1010) with the process terminating thereafter.

In this embodiment, the preference service is retrieving preferences from a remote data storage device. The preferences were not created by a user through the preference service on the electric vehicle. Instead, the preferences were generated by a primary preference service located on a computing device that is remote to the electric vehicle based on user inputs and user selections of preferences. The preferences are not generated at the vehicle preference service located on the vehicle. Therefore, the vehicle preference service retrieves the preferences from the removable data storage device to obtain the preferences and then forwards the preferences of interest onto the energy transaction planner.

Returning to step 1004, if the preferences are available on a data storage device associated with the vehicle preference service, the preference service retrieves the preferences of interest that are responsive to the request from the data storage to form a set of preferences for the principal (step 1012). The preference service sends the set of preferences to the energy transaction planner (step 1010) with the process terminating thereafter. In this embodiment, the preferences may be been created for the user based on user inputs on a computing device that is remote from the electric vehicle. The preferences may then be transferred to the storage device on the electric vehicle for permanent or semi-permanent storage by means of either a removable storage device or by a network connection.

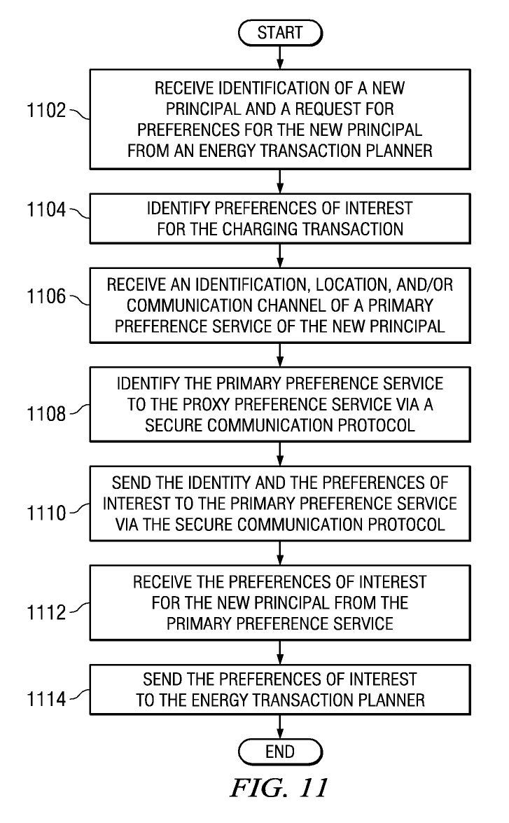

FIG. 11 is a flowchart illustrating a process for accessing preferences for a principal by a proxy preference service in accordance with an illustrative embodiment. The process in FIG. 11 is implemented by an energy preference service on an electric vehicle, such as proxy preference service 502 in FIG. 5.

The process begins by receiving an identification of a new principal and a request for preferences for the new principal from an energy transaction planner (step 1102). The proxy preference service identifies preferences of interest for the charging transaction (step 1104) that are responsive to the request. The proxy preference service receives identification of the primary preference service, location of the primary preference service, and/or communication channel of a primary preference service of the new principal (step 1106). The proxy preference service identifies itself to the primary preferences service via the secure communication protocol (step 1108).

The proxy preference service sends the identity of the preferences of interest to the primary preference service via the secure communication protocol (step 1110). The proxy preference service receives the preferences of interest for the new principal from the primary preference service (step 1112). The proxy preference service then sends the preferences of interest to the energy transaction planner (step 1114) with the process terminating thereafter. The energy transaction planner then uses the preferences received from the proxy preference service to generate an energy transaction plan.

Referring now to FIG. 12, a flowchart illustrating a process for retrieving a set of preferences by a primary preference service in response to a request by a proxy preference service is depicted in accordance with an illustrative embodiment. The process in FIG. 12 is implemented by an energy preference service on a remote computing device, such as primary preference service 504 in FIG. 5.

The process begins by establishing a secure communication with a proxy preference service (step 1202). The primary preference service receives the identity of a principal and a request for preferences of interest for the principal from the proxy preference service (step 1204). The primary preference service identifies preferences for the principal that are responsive to the request to form a set of preferences (step 1206).

In another embodiment, the primary preference service may authenticate the identify of the requesting preference service and authenticate the identity of the principal. The primary preferences service may then retrieve the identified preferences from the local data storage device on the remote computing device prior to sending the preferences to the proxy preference service. The primary preference service sends the set of preferences to the proxy preference service (step 1208) with the process terminating thereafter. The proxy preference service forwards the set of preferences onto an energy transaction planner for use in generating an energy transaction plan to govern an electric vehicle charging transaction in which the principal is an owner or operator of the electric vehicle.

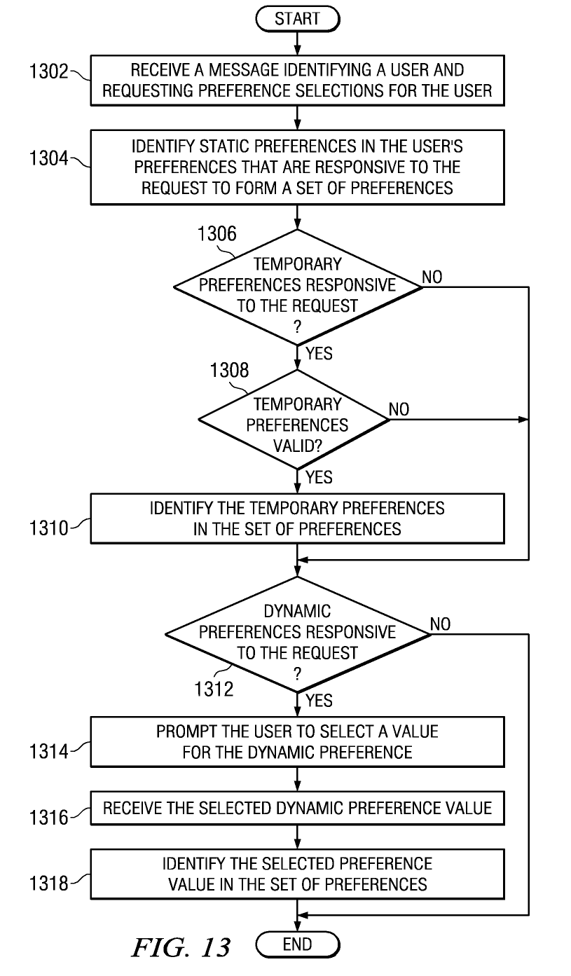

FIG. 13 is a flowchart illustrating a process for identifying a set of preferences for an identified principal by a preference service in accordance with an illustrative embodiment. The process in FIG. 13 is implemented by an energy preference service on an electric vehicle, such as vehicle preference service 402 in FIG. 4. The process in FIG. 13 is a more detailed description of steps 902-904 in FIG. 9.

The process begins by receiving a message identifying a user and requesting preference selections for the user (step 1302). The preference service identifies static preferences in the user's preferences that are responsive to the request, such as static preference 608 in FIG. 6, to form a set of preferences (step 1304). A preference that is responsive to a request is a preference that is a type of preference of interest to the transaction. For example, an energy transaction planner may be concerned with identifying how long to charge an electric vehicle. In such a case, the types of preferences of interest that are responsive to the request may include amount of charge 514 and time 512 in FIG. 5 while preferences associated with de-charging and storage preferences may not be responsive to the request.

The preference service makes a determination as to whether any temporary preferences, such as temporary preferences 612 in FIG. 6, are responsive to the request (step 1306). If any temporary preferences are responsive to the request, the preference service makes a determination as to whether the temporary preferences are valid (step 1308). A temporary preference may be invalid if the time period during which the temporary preference is valid is expired. If the temporary preference is valid at step 1308, the preference service identifies the temporary preferences in the set of preferences (step 1310). In other words, the valid temporary preferences that are responsive to the request are included in the set of preferences along with the static preferences.

The preference service determines whether any dynamic preferences are responsive to the request (step 1312). If none of the dynamic preferences are responsive to the request, the process terminates thereafter. If one or more of the dynamic preferences for the user is responsive to the request, the preference service prompts the user to select a value for the dynamic preference (step 1314). A value for a dynamic preference is a selected setting or choice for the dynamic preference. The preference service receives the selected value for the dynamic preference from the user (step 1316). The preference service identifies the selected dynamic preference value in the set of preferences (step 1318). In other words, the selected dynamic preference is included in the set of preferences for the user, in addition to the static preferences and any temporary preferences responsive to the request, with the process terminating thereafter.

According to one embodiment of the present invention, a computer implemented method, apparatus, and computer usable program product for managing user preferences on remote computing devices for utilization in electric vehicle charging transactions is provided. A first preference service receives a first request for preferences of interest for an identified principal from an energy transaction planner. In response to a determination that preferences for the identified principal are unavailable on a first data storage device associated with the first preference service on a first computing device, the first preference service makes a determination as to whether the preferences are available on a removable data storage medium that is accessible by the first preference service or available on a second data storage device associated with a second preference service on a second computing device. A preference specifies a parameter of an electric vehicle charging transaction that is to be minimized, maximized, or optimized.

In response to a determination that the preferences for the identified principal are available on the removable data storage medium, the first preference service retrieves a set of preferences that are responsive to the first request from the preferences stored on the removable data storage medium. In response to a determination that the preferences for the identified principal are stored on a second computing device associated with a second preference service, the first preference service sends a second request for the set of preferences to the second preference service using a network connection. The second preference service retrieves the set of preferences that are responsive to the first request and the second request. The second preference service sends the set of preferences to the first preference service. The first preference service receives the set of preferences from the second preference service and sends the set of preferences to the energy transaction planner for utilization in managing the electric vehicle charging transaction. The first preference service acts as a proxy for the energy transaction planner and the second preference service.

The primary preference service and proxy preference service simplifies the user input/output components on a vehicle preference service. In addition, the utilization of a removable data storage medium in conjunction with a primary preference service on a remote computing device provides a means for non-regular operators of an electric vehicle to provide their preferences to a vehicle preference service and precludes the need for a proxy preference service.

The embodiments permit preferences to be created at a computing device that is located remotely or detached from the electric vehicle that may provide a better and more user friendly input/output interface. The preferences created at this remote computing device may be transferred from the remote computing device using a removable data storage device or a network connection to send the preferences to the vehicle preference service for permanent, semi-permanent, or temporary storage on-board the electric vehicle. The embodiments may also be used to provide the preferences to the vehicle preference service using the removable data storage device and/or a network interface, on-demand. In other words, the preferences may be retrieved from the removable data storage device or received over the network for utilization, on-demand, in a single transaction or a limited number of transactions. In other words, the removable data storage device may be used just to copy preferences from the remote computing device over onto the vehicle preference service storage device and/or the removable data storage device may be used only as a temporary location for the vehicle preference service to look for preferences not stored on the electric vehicle. This may be beneficial in cases of temporary users of the electric vehicle, such as users that rent or borrow the electric vehicle for a single trip or for a limited amount of time.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method of managing user preferences on remote computing devices for utilization in electric vehicle charging transactions, the computer implemented method comprising:
receiving, by a first preference service on a first computing device, a request for a set of preferences for an identified principal, from an energy transaction planner;
determining whether the set of preferences are available on a removable data storage device that is accessible by the first preference service or available on a second data storage device associated with a second preference service on a second computing device, wherein a preference in the set of preferences specifies a parameter of an electric vehicle charging transaction that is to be minimized, maximized, or optimized;
responsive to a determination that the set of preferences for the identified principal are available on the removable data storage device, retrieving the set of preferences from the removable data storage device;
responsive to a determination that the set of preferences are available on the second computing device associated with the second preference service, sending, by the first preference service, a request for the preferences of interest for the identified principal to the second preference service and receiving the set of preferences from the second preference service, wherein the first preference service is a proxy for the second preference service; and
sending the set of preferences to the energy transaction planner.

2. The computer implemented method of claim 1 wherein sending the request to the second preference service further comprises:
receiving at least one of an identification, location, and communication channel of the second preference service, wherein the second preference service is a primary preference service of the principal;
identifying the first preference service to the second preference service via a secure communication protocol; and
sending an identity of the principal and the request for the set of preferences to the second preference service using the secure communication protocol, wherein the set of preferences for the identified principal are received from the second preference service using the secure communication protocol.

3. The computer implemented method of claim 1 further comprising:
establishing a secure communication session with the first preference service, by the second preference service;
receiving an identity of the principal and a request for the set of preferences from the first preference service;
retrieving the set of preferences that are responsive to the request from the first preference service; and
sending the set of preferences to the first preference service by the second preference service.

4. The computer implemented method of claim 1 further comprising:
prompting the identified principal to enter at least one preference selection, by the second preference service;
receiving the preferences selected by the principal, by the second preference service to form selected preferences for the identified principal;
storing the selected preferences in the second data storage device located locally to the second preference service on the second computing device, wherein the second data storage device is inaccessible to the first preference service and the energy transaction planner; and
responsive to identification of the removable data storage device as a removable data storage device that is accessible to the second preference service, storing the preferences on the removable data storage device by the second preference service, wherein the first preference service is able to access the set of preferences stored on the removable data storage device when the removable data storage device is unplugged from a port associated with the second computing device and plugged into a port associated with the first computing device.

5. The computer implemented method of claim 1 further comprising:
retrieving a weighting value associated with each preference in the set of preferences; and
sending the weighting value associated with the each preference in the set of preferences to the energy transaction planner, wherein the weighting value indicates a priority of each preference in relation to other preferences in the set of preferences.

6. The computer implemented method of claim 1 wherein retrieving the preferences further comprises:
responsive to identifying a temporary preference in the preferences of interest, determining whether the temporary preference is valid, wherein a temporary preference is a preference that is only valid for a predetermined period of time or a predetermined number of charging transactions; and
responsive to a determination that the temporary preference is valid, including the temporary preference in the set of preferences.

7. The computer implemented method of claim 1 wherein retrieving the preferences further comprises:
responsive to identifying a dynamic preference in the preferences of interest, prompting a principal to select a preference value for the dynamic preference, wherein the dynamic preference is a preference that requires a selection of the preference value by the principal in real time as the set of preferences is being generated; and
responsive to receiving the selection of the preference value for the dynamic preference, including the dynamic preference and the value selected for the dynamic preference in the set of preferences.

8. The computer implemented method of claim 1 wherein each preference is associated with an indicator that indicates whether the preference is mandatory or optional, wherein all requirements of a mandatory preference are met during the charging transaction, and further comprising:
responsive to a determination that the mandatory preference is unsatisfied, terminating the charging transaction.

9. The computer implemented method of claim 1 wherein the first preference service and the energy transaction planner are located on an electric vehicle associated with the electric vehicle charging transaction.

10. The computer implemented method of claim 1 wherein the first preference service and the energy transaction planner are located on a first remote computing device that is located remotely to the electric vehicle, and wherein the primary preference service is located on a second remote computing device.

11. The computer implemented method of claim 1 further comprising:
responsive to a determination, by the second preference service, that the identified principal has previously selected preferences to form current preferences, retrieving the current preferences for the identified principal and presenting the preferences to the identified principal;
responsive to receiving a selection to enter changes to the current preferences by the identified principal, prompting the user to enter the changes to the current preferences;
receiving the changes to the preferences; and
storing the changes to the current preferences in the second data storage device to form updated preferences for the identified principal;
retrieving the preferences of interest from the updated preferences to form an updated set of preferences in response to the second request from the first preference service; and
sending the updated set of preferences to the first preference service.

12. The computer implemented method of claim 1 further comprising:
presenting the set of preferences retrieved from the removable data storage device to the identified principal;
responsive to receiving a selection from the identified principal to enter changes to the set of preferences retrieved from the removable data storage device, prompting the user, by the first preference service, to enter the changes to the set of preferences;
receiving the changes to the set of preferences; and
storing the changes to the set of preferences in the removable data storage device to form updated preferences for the identified principal.

13. A computer implemented method of managing preferences for managing charging transactions by a primary preference service, the computer implemented method comprising:
receiving an identification of a principal using a user interface associated with a client computing device by the primary preference service at the first computing device, wherein the principal is an entity having an interest in an electric vehicle charging transaction, and wherein the charging transaction is a transaction associated with at least one of charging an electric vehicle, storing electric power in an electric storage mechanism associated with the electric vehicle, and de-charging the electric vehicle;
receiving a selection of preferences from the principal to form a set of preferences for the principal, wherein a preference in the set of preferences specifies a parameter of the charging transaction that is to be minimized, maximized, or optimized;
responsive to receiving a selection to store the set of preferences on a removable data storage device that is plugged into a port associated with the first computing device, storing the set of preferences on the removable data storage device, wherein the principal unplugs the removable data storage device having the set of preferences stored thereon from the port associated with the first computing device and plugs the removable data storage device into a port associated with a second data storage device associated with a vehicle preference service, and wherein the vehicle preference service is located on an electric vehicle, and wherein the vehicle preference service copies the set of preferences from the removable data storage device onto a local data storage device associated with the second computing device.

14. The computer implemented method of claim 13 wherein the vehicle preference service sends a subset of preferences in the set of preferences for the principal to an energy transaction planner in response to receiving a request from the energy transaction planner for preferences of the principal for a particular charging transaction.

15. The computer implemented method of claim 13 further comprising:
responsive to receiving a selection to transmit the set of preferences to the vehicle preference service over a network interface, identifying a location of the vehicle preference service; and
sending the set of preferences to the vehicle preference service via the network interface, wherein the vehicle preference service saves the set of preferences for the principal onto the local data storage device associated with the second computing device for utilization in managing electric vehicle charging transactions associated with the principal.

16. The computer implemented method of claim 13 wherein the network interface is a wireless network interface that establishes a network connection between the first computing device and the second computing device.

17. A computer program product comprising:
a computer usable medium including computer usable program code for managing user preferences on remote computing devices for utilization in electric vehicle charging transactions, said computer program product comprising:
computer usable program code for receiving, by a first preference service on a first computing device, a request for a set of preferences for an identified principal, from an energy transaction planner;
computer usable program code for determining whether the set of preferences are available on a removable data storage device that is accessible by the first preference service when the removable data storage device is plugged into a port associated with the first computing device or available on a second data storage device associated with a second preference service on a second computing device, wherein a preference in the set of preferences specifies a parameter of an electric vehicle charging transaction that is to be minimized, maximized, or optimized;
computer usable program code for retrieving the set of preferences from the removable data storage device in response to a determination that the set of preferences are available to the first preference service on the removable data storage device;
computer usable program code for sending a request for the set of preferences to the second preference service and receiving the set of preferences from the second preference service, by the first preferences service, in response to a determination that the set of preferences for the identified principal are available on the second remote computing device associated with the second preference service, wherein the first preference service is a proxy for the energy transaction planner and the second preference service; and
computer usable program code for sending the set of preferences to the energy transaction planner.

18. The computer program product of claim 17 further comprising:
computer usable program code for prompting the identified principal to enter a set of preference selections, by the second preference service;
computer usable program code for receiving the preferences selected by the principal, by the second preference service to form selected preferences for the identified principal;
computer usable program code for storing the selected preferences in the second data storage device located locally to the second preference service on the second computing device, wherein the second data storage device is inaccessible to the first preference service and the energy transaction planner; and
computer usable program code for storing the selected preferences on the removable data storage device by the second preference service in response to identification of the data storage device as a removable data storage device that is plugged into a port associated with the second computing device and accessible to the second preference service, wherein the first preference service is able to access the selected preferences stored on the removable data storage device when the removable data storage device is unplugged from the port associated with the second computing device and plugged into the port associated with the first computing device.

19. The computer program product of claim 17 wherein the first preference service and the energy transaction planner are located on the electric vehicle.

20. A system for managing user preferences for utilization in electric vehicle charging transaction, the system comprising:
a first preference service on a first computing device, wherein the first preference service manages preferences for a set of principals associated with an electric vehicle;
a first data storage device associated with the first computing device, wherein a set of preferences for an identified principal are unavailable on the first data storage device;
a third data storage device, wherein the third data storage device is a removable data storage device storing preferences, and wherein the first preference service retrieves the set of principals for the identified principal from the second data storage device in response to a determination that the second data storage medium is plugged into a port associated with the first computing device and accessible by the first preference service; and
a network interface, wherein the first preference service connects to a second preference service on a second computing device using the network interface to form a network connection in response to a determination that the set of preferences are available on a third data storage device associated with the second computing device, and wherein the first preference service sends a request for the set of preferences to the second preference service using the network connection and receives the set of preferences from the second preference service over the network connection, wherein a preference in the set of preferences specifies a parameter of an electric vehicle charging transaction that is to be minimized, maximized, or optimized, and wherein the first preference service acts as a proxy for the energy transaction planner and the second preference service and sends the set of preferences to the energy transaction planner.
